(19) United States
(12) Patent Application Publication
(10) Pub. No.: US 2016/0005116 A1
(43) Pub. Date: Jan. 7, 2016

(54) EVENT AND STRATEGY DRIVEN FINANCIAL TRANSACTIONS METHOD AND SYSTEM

(71) Applicant: ALGOFAST LLC, Chicago, IL (US)

(72) Inventors: Justin Bouchard, Chicago, IL (US); Jonathan M. Fimek, Chicago, IL (US); Rakesh M. Patel, Chicago, IL (US)

(73) Assignee: ALGOFAST LLC, Chicago, IL (US)

(21) Appl. No.: 14/321,548

(22) Filed: Jul. 1, 2014

(51) Int. Cl. G06Q 40/04; G06F 17/30

(52) U.S. Cl. CPC G06Q 40/04; G06F 17/30386

(57) ABSTRACT

A system and method for creating event-driven financial transactions may include: a web service in communication with a plurality of users, the web service operatively coupled to a strategy database storing a plurality of pending transactions and an event database storing identification information about a plurality of transaction triggering events. The web service may be in communication with a data parser that is configured to receive data from one or more sources, convert the data into a format usable by the system, and transmit the converted data to the event database. The system may be in communication with a separate server to which transactions from server or client side matching engines are sent, and the strategy database may receive and at least temporarily store those transactions until the server is ready to receive and store them. Strategy triggers may come from various places, including from the user.

### BACKGROUND OF THE INVENTION

1. Field of the Invention

The present invention is directed generally to computer systems and methods configured to make automated financial trading faster, more robust, and more efficient.

2. Description of the Related Art

Stocks, bonds, mutual funds, commodities, contracts, and other financial products are traded continuously in markets around the world. It is impossible to predict all the factors that may affect the price of these contracts, particularly as there is a wealth and, some might say, an overload of information available to consider. Financial trading systems and methods such as those in the co-pending U.S. application Ser. No. 13/167,018, filed Jun. 23, 2011, Ser. No. 13/250,427, filed Sep. 30, 2011, and Ser. No. 13/451,645, filed Apr. 20, 2012 have been created to permit users to generate trading strategies that depend on fulfillment of one or more triggers based on events occurring every day—both scheduled and unscheduled—and make automated trade execution triggered by those events.

In addition to the methodologies described and claimed in those applications, it may be beneficial to provide users with more transaction triggers and with more information to make better informed decisions when executing transactions.

Moreover, conditions relating to companies, commodities, options, derivatives, and other investments can change at a moment's notice. As such, a system that executes trades more quickly than other systems, with the ability to automate execution of those trades by responding to news events and other outside inputs, may be preferred over those other systems

Therefore, there exists a need for a method and system for event-driven financial trading that provides users with multiple options for establishing transactions (that may generate orders) based on varying types of events. Once it is determined that the triggering condition or conditions are met, there also is a need to have those orders filled quickly through automated computerized trade execution.

### SUMMARY OF THE INVENTION

In one aspect, a system for creating event-driven financial transactions may include: a front end user interface (either web-based or a downloadable application), a matching engine in communication with a plurality of users either through a web server or downloadable application coupled to a strategy database storing a plurality of pending transactions, and an event database storing identification information about a plurality of transaction triggering events. The matching engine may be in communication with a data parser that is configured to receive data from one or more sources, convert the data into a format usable by the system, and transmit the converted data to the event database. The event parser may be configured to parse the data, e.g., into JSON format, and it may receive data according to at least one of a TCP/IP protocol and a UDP transmission model.

The event database may include first and second tables, each table including a first column containing user identifications that are unique to each user, and a second column containing strategy record identifications that correspond to an entry in the strategy database. In addition, the first table may include a third column containing a complete strategy record, and the second table may include a third column containing event identifications, the event identifications being unique to each of the transaction triggering events. Other table structures are possible, provided the database can store and accurately maintain a relationship between each user and his or her desired strategies.

A strategy may include a plurality of transaction triggering events, and the second table may include a separate row for each of the transaction triggering events for the transaction. At least one of the pending transactions may include instructions to wait a user-defined period of time after the occurrence of one of the transaction triggering events before carrying out an order.

Transaction triggering events may come from multiple sources. For example, a trigger may be user-defined. Alternatively, a trigger may relate to a change in a rating agency rating of a contract or a change in an average rating of a trigger when multiple agencies rate a contract.

In another aspect, a method for generating and executing a financial transaction may occur on a cloud-based computer system that includes a web service in communication with a plurality of users, the web service operatively coupled to a strategy database storing a plurality of pending strategies (strategies may include the event or cause of a trade and the order, i.e., the contract, price, quantity, expiry, etc.) and an event database storing information about a plurality of events, the web service in communication with a data parser, the data parser configured to receive data from one or more sources, convert the data into a format usable by the system, and transmit the converted data to the event database. The method may include the steps of receiving a plurality of proposed transactions from a plurality of user computers, storing, for each proposed transaction, a first set of information relating to the transaction in the strategy database, storing, for each proposed transaction, a second set of information relating to the transaction in the event database, receiving a notification from the data parser regarding a change relating to a transaction triggering event, searching the event database for all matching transactions that depend upon the change, retrieving, from the strategy database, the matching transactions, determining whether all triggering events for the matching transactions are met, and transmitting, by the web service, orders corresponding to the matching transactions with all triggering events being met to a broker or to an exchange to be filled. Transmission to the broker or exchange may be direct or, alternatively, may occur indirectly by first sending the orders to a separate web application or client, which then eventually routes orders to the broker.

The event database may include first and second tables, and the method further may include the steps of storing, in the first and second tables, a first column of data containing user identifications, the user identifications being unique to each user, and a second column of data containing strategy record identifications, each strategy record identification corresponding to an entry in the strategy database, storing, in the first table, a third column of data containing a complete strategy record, and storing, in the second table, a third column of data containing event identifications, the event identifications being unique to each of the transaction triggering events. Again, other table structures are possible, provided the database can store and accurately maintain a relationship between each user and his or her desired strategies.

A strategy may include a plurality of transaction triggering events or other constraints, and the method further may include the step of storing, in the second table, a separate row for each of the transaction triggering events for the transaction.

The method also may include the steps of receiving and storing a user-defined transaction triggering event. Additionally or alternatively, at least one of the transaction triggering events may relate to a change in a rating agency rating of a contract or, if multiple agencies rate a contract, the method may include determining a change in an average among the ratings and utilizing the change in average as a transaction triggering event.

At least one of the pending transactions may include instructions to wait a user-defined period of time after the occurrence of one of the transaction triggering events before carrying out an order.

In addition, the method may include the steps of storing historical information relating to changes in the price of a contract, storing historical information identifying the times and amounts of changes to a transaction triggering event, and mapping a relationship between the changes to the triggering event and the changes in price of the contract.

The method further may include the steps of storing historical information relating a plurality of different releases of a numerically quantifiable transaction triggering event, the historical information including actual and expected values of an event and the delta between the two at and after occurrences of the event, calculating an average change over time between the price and delta, calculating a standard deviation for the average change over time, receiving a user selection of a time after occurrence of the transaction triggering event and delta, and displaying to the user, for the time selection, an average change in the price of the contract.

These and other features and advantages are evident from the following description, with reference to the accompanying drawings.

### BRIEF DESCRIPTION OF THE SEVERAL VIEWS OF THE DRAWINGS

FIG. 1 is one example of a web-based system implementation for event-driven trading.

FIG. 2 is an example of the co-implementation of cloud-based and server side matching engine system implementation for event-drive trading.

FIG. 3 is an example of client side matching engine system implementation for event-driven trading.

FIG. 4 is an example of data flow in the client side matching engine implementation.

FIG. 5 is an example of server side matching engine system implementation for event-driven trading.

FIG. 6 is an example of data flow in the server side matching engine implementation.

FIGS. 7A-B are screenshots of an analytical tool for evaluating a historical data

FIG. 7C is a graphical tool for analyzing average price move based on historical data

FIG. 8 is a mockup of example of user selections for generating a strategy based on a user-defined event.

### DETAILED DESCRIPTION OF THE INVENTION

Various aspects of a system and method for generating and executing financial trades are described herein. As described in greater detail below, the system and method take advantage of novel system configurations in order to make the system more readily and remotely available to a user. The system also is configured to generate user-defined transactions and then execute those transactions in a faster, more technically efficient manner than traditional methods of transaction generation.

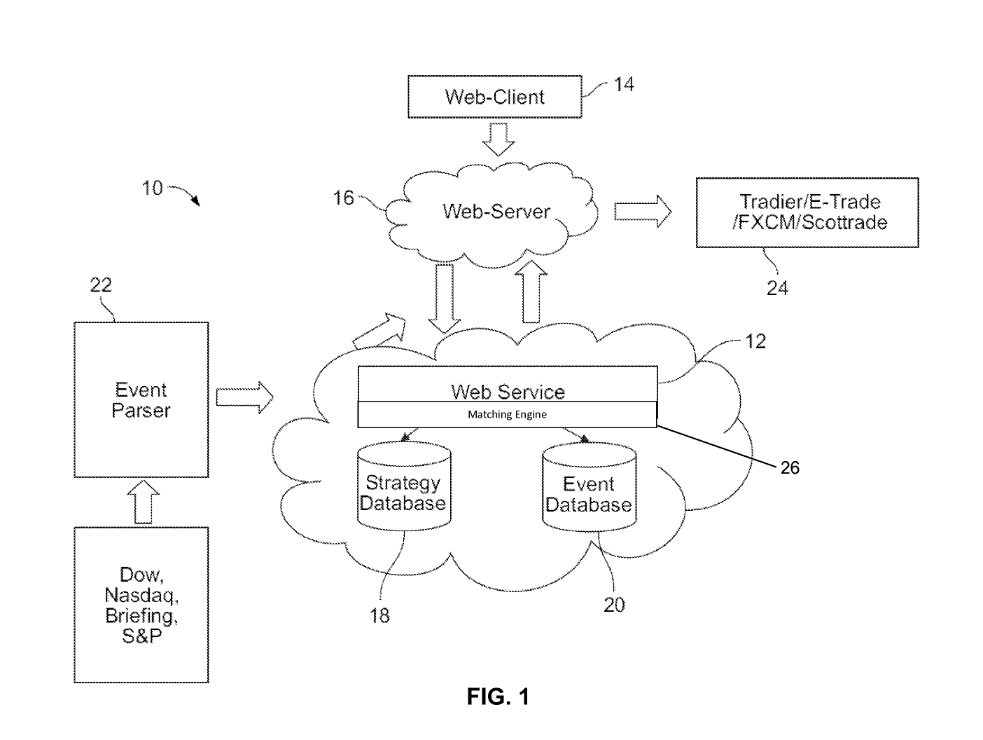

FIG. 1 illustrates a web-based version in which system 10 may be configured to have a cloud-based matching engine or a web front end. System 10 may include a web service 12 in communication with one or more clients 14 via a web-server 16. In one aspect, web service 12 may be considered an application programming interface (API), and web service may be in communication with users via a web service or via Software as a Service (SaaS) via a web browser on a user's client side device.

Instead of storing strategies locally on a user's machine, it may be desirable to store those strategies remotely, e.g., on a server or in the cloud. A strategy is created on the website, and sent to a server or the cloud to await the release of a news item. All strategies entered by the user are stored in a Strategy Database. Among other things, this may have the benefit of permitting a user to have remote access to those strategies.

A web-based system also may have the benefit of permitting more frequent and/or easier system updates. For example, it may be desirable to add additional functionality to the system or to change the visual layout. In a downloadable application, the system may need to update the current version on each user's machine, e.g., for compatibility. Conversely, a web-based front end may be corrected once, and those corrections or updates then would be instantly updated to all users at the same time.

As such, users may submit strategies to strategy database 18 via web service 12. Upon being pushed to strategy database 18, a strategy state may be set to PENDING, waiting for an event, etc.

In addition, system 10 may include an event database 20, which may comprise a relational database, and which may store historical data relating to a plurality of events. Events may serve as triggers, and historical data may include actual and estimated event values, as well as data reflecting differences between the actual and estimated values revolving around the time periods at which the event values are released or changed.

Data used to populate event database 20 will be received from an event parser 22 hosted on a computer, the parser in communication with web service 12, unless the data is structured by the news provider in a format that already is compatible with the system messaging format. Event parser 22 may receive data from a plurality of sources in one or more machine-readable formats, e.g., XML or Binary. Data may be transmitted to event parser in one or more manners that would be appreciated by one of ordinary skill, e.g., via TCP/IP protocol and/or using a UDP transmission model. Once it receives the data, parser 22 may parse it into categories or other smaller units and transmit the parsed data to event database 20, where it may be used by system 10.

Strategy database 18 and event database 20 preferably are not exposed directly to end users. Instead, web service 12 may serve as a bridge between them and users, thereby permitting users to query/use the data stored in event database 20 and to update the strategy database with their desired transactions. For example, users may interface with web service 12 via an application that seeks to use the data, and developers may access web service 12 or via a dedicated Application Programming Interface (API).

As discussed in greater detail below, when new events occur or changes to existing event data are received by event parser 22 and data relating to the change is submitted to event database 20, the matching engine 26 analyzes strategies stored in strategy database 18 to determine whether any matches exist with new events added to the event database 20. Also as discussed in greater detail below, system 10 may implement one or more methods for optimizing this analysis, so as to improve execution time and minimize drain on system processor or other system resources.

If matching engine within web service 12 encounters a match within strategy database 18, such that all conditions to execute a trade are met, an order tied to the strategy is routed to a brokerage or exchange 24, e.g., via web server 16, to be filled. In that case, strategy database 18 may be updated by changing strategy state to EXECUTED. Associated order information also may be updated to whatever the broker or exchange API responds with. Such a methodology may eliminate a need for polling scheduled strategies and is done to track long-running unscheduled strategies.

A Strategy Matching Engine is used to cross reference the Strategy Database 38 with the Event Database 40. When a news release hits the Event Database 40, the Strategy Matching Engine 26 checks the Strategy Database 38 to see if anyone has created a strategy with that individual event release ID. If a match is made, the strategy is triggered, and a signal is sent through the Matching Engine API 42 which communicates with the AlgoFast Web Application 50. From there, the order or orders associated with the triggered strategy are sent to the brokerage or exchange that the user assigned in the strategy.

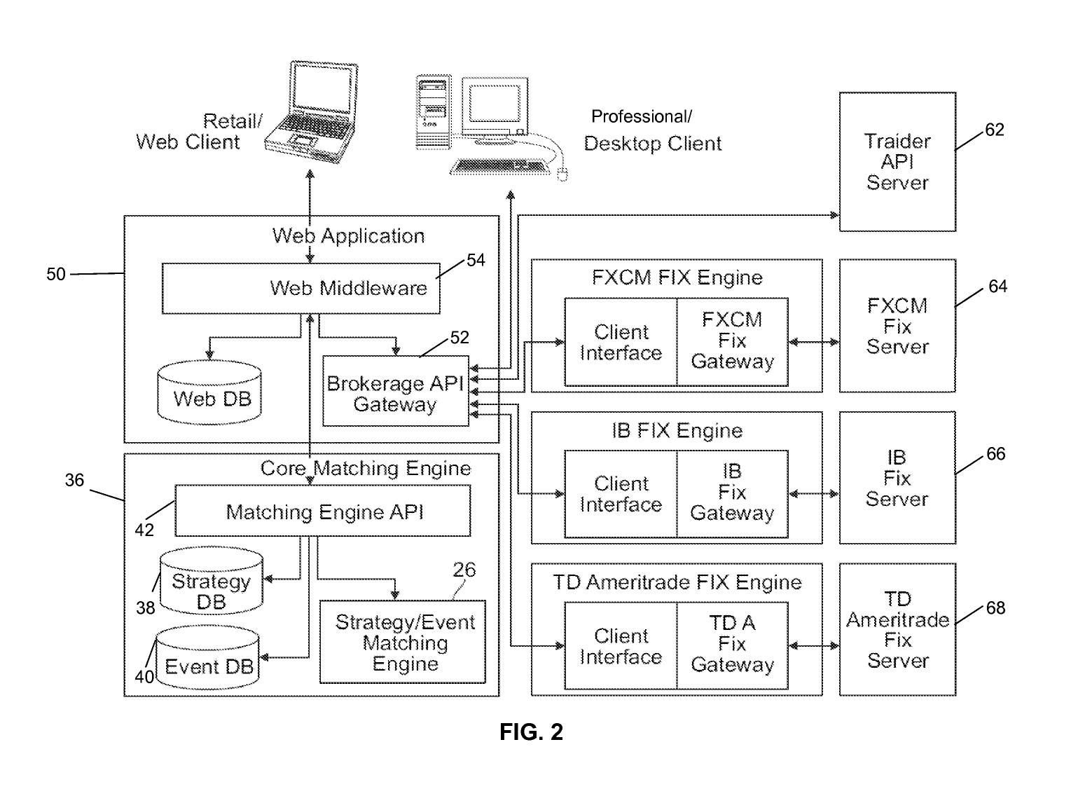

The system may be configured to connect with brokerage 24 (shown on the right half of FIG. 2) using a language independent API like the one offered by Traider 62, or to a FIX (Financial Information Protocol) API like the ones offered by Interactive Brokers (IB) 66 TD Ameritrade 68 or FXCM 64. Exemplary programming languages used by the system may include HTML, or C++/C#.

In an alternative embodiment, a user may wish to utilize the system to execute a transaction that does not rely on a strategy, i.e., it does not require a condition relating to one or more triggers being met before the order is placed. In this situation, the order may be delivered directly to the brokerage 24 via web server 16 and not stored by the system for analysis.

In one example, as shown in FIG. 1, web service 12 may be a Windows Communication Foundation (WCF) service hosted on a Microsoft Windows Azure Cloud, although other hosts are possible. In one embodiment, incoming requests and outgoing responses to and from web service 12 may be formatted in JavaScript Object Notation (JSON), although other protocols may be used.

Event database 20 may be a relational database such as a relational SQL database hosted in Microsoft Windows Azure Cloud. In a relational database, each value represents a place in the hierarchy of a group. Each status captures a degree of positivity or negativity in relation to the other possible values. For example strong buy would have a higher value than buy, which would be higher than hold or sell.

Web Service 10 may receive requests for historical information and respond to those requests. Requests may come from multiple types of sources, e.g., directly from a web client or from a research tool. Web Service 10 may obtain the historical information from event database 20, put the data into JSON format, and send the JSON as a reply to the request.

Conversely, strategy database 18 and/or event database 20 may be a non-SQL database such as Windows Azure Table Storage hosted in Microsoft Windows Azure Cloud, i.e., strategy database may be a non-relational database. Web service 12 may provide a REST interface to perform create/retrieve/update/delete (CRUD) operations for one or more strategies. This database may include a plurality of rows, each row representing a strategy that has been submitted by a user to the web service 12. Columns may include, e.g., a first column containing user identifications (each user's ID is unique), a second column containing unique strategy record identifications (each strategy has a unique ID), and a third column containing a complete JSON formatted strategy record. Other table structures are possible, provided the database can store and accurately maintain a relationship between each user and his or her desired strategies.

Strategy database 18 may comprise a plurality of databases in communication with one another. In addition to the database discussed in the previous paragraph, strategy database 18 may include a second non-SQL database (or another table within the database) that stores information on proposed transactions until those strategies are triggered. (In one embodiment, those strategies may be stored in the second database or in another database even after being triggered, in order to provide the user with a historical record of the strategies he or she created.) As with the other database, this database may include a column containing unique strategy record identifications and a second column with an unique user identification. The table in this database also may include an event ID, which may be a unique identification assigned to each event. Identifiers may be supplied by news feed providers, may be formed by concatenating or otherwise manipulating information from news feed providers, or may be generated independently by system 10. Records in this database may be temporary and may be deleted when a strategy triggers or when it fails to trigger and is set to “Single Cycle,” as discussed below.

When a user submits a strategy from a front end, the appropriate rows of each of these tables may be populated, where each row may represent a constraint within a strategy. It may be possible that a single strategy will populate multiple rows within a table, or a single row in multiple tables, or multiple rows in multiple tables. For example, a strategy that includes three different events as a trigger may cause one record/row to be added in the first database and three records/rows to be added to the second database, depending on which constraints are independent or dependent/mutually inclusive. A user may separate constraints, e.g., with an “OR” button for independent constraints or an “AND” button for mutually inclusive or dependent constraints.

On event arrival, web service 12 gets notified of a new event from event parser 22. A first lookup may be performed in the second database/table within strategy database 18 in order to find all strategies waiting for that incoming event. Once found, a second look up may be performed in the first database/table within strategy database in order to fetch strategies matching the user ID and strategy record ID. If any such records are found, they may be processed in parallel (using thread pool, see optimization techniques section) to check if there is a match. If a match is found, the order will be sent out to exchange 24, e.g., via web-server 16.

Event parser 22 may be a Windows service that receives event information, e.g., news feeds via UDP and TCP/IP. As stated above, web service may receive inputs in a variety of formats, such that event parser may use HTTP POSTs to send a converted JSON to the web service. Event parser 22 may be hosted on one or more servers with access to the data streams, and there may be more than one event parser 22 employed in order to parse multiple feeds.

Exemplary strategies may include one or more of the following types: simple strategies, basket strategies, and complex strategies. A simple strategy may be one with only a single constraint/trigger. For example, “If GDP growth >2%, I will buy [or sell] 50 shares of ABC at $100/share” may be considered a simple strategy.

A basket strategy may be one with multiple constraints/triggers. Such triggers may be coupled with second or multiple constraints, e.g., “AND” constraints. The strategy “If GDP growth >2% [AND/OR] Unemployment <6.5%, I will buy [or sell] 50 shares of ABC at $100/share” may be considered a basket strategy. All constraints in the basket strategy must be true for the strategy to be triggered.

A complex strategy may be one with multiple baskets of constraints/triggers, where each basket may include one or multiple constraints/triggers. The strategy “(If [trigger1]>[predicted value] AND [trigger2]>[predicted value]) OR (If [trigger3]>[predicted value] AND [trigger4]>[predicted value]), I will [buy/sell] [#] shares of [contract] at [price per share]” may be considered a complex strategy. Because they are separated by the operator “OR,” either basket could trigger the strategy independently.

Strategies may include a duration for which they are active. One such duration may be “Single Cycle.” In this case, the strategy remains active until the release of the trigger/event. If the condition on the trigger is met, the strategy is executed and the order is sent. In the event there are multiple triggers, the strategy will remain active until the last of its triggers is released for the first time after the strategy was created. This is because certain first triggers may be released multiple times before a second trigger, so it may be possible for the first trigger to be considered false before being considered true, followed by the second trigger being met, which would cause the strategy to be executed.

An alternative duration may be “Continuous.” In this case, the strategy will always remain active until it finally is triggered, regardless of the number of times the trigger is released. For example, one strategy may be: “If the US GDP growth falls below 1%, I will sell stock ABC.” A user can let this strategy run for many months so that, even if the first month's GDP comes out above 1%, the strategy still would be active for the second month's GDP release.

A third duration may be “Partial Cycle.” This strategy may differ from both Single Cycle and Continuous in that, whether one or more than one trigger is used, the strategy only will be executed if each trigger is met the first time it is released.

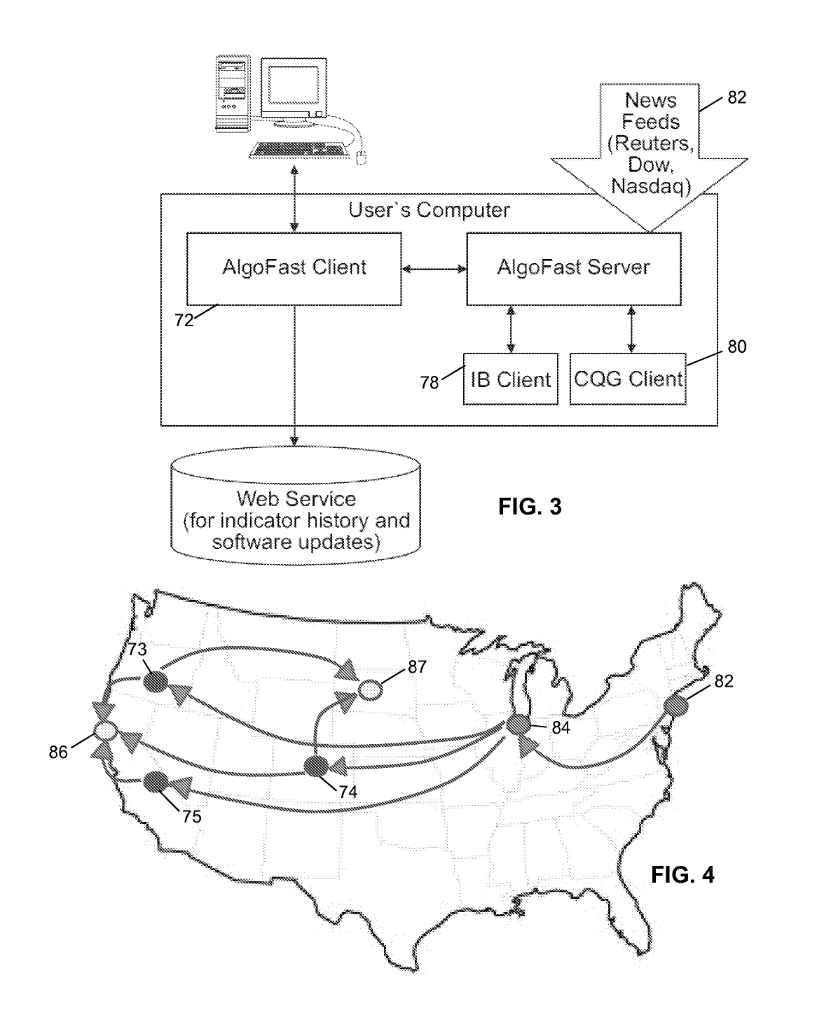

A similar system is shown in FIG. 2, illustrating the way in which a web client may differ from a locally-installed or desktop client. As seen in FIG. 2, the web client may need to connect through a web service such as the Web Middleware 54 shown in the figure, which is in communication with an API gateway 52 in order to communicate with one or more brokerages. In comparison, as shown in FIG. 3, the desktop client may interface directly with the gateway, without the need to pass through a middleware layer.

The Strategy Matching Engine 26 in FIG. 2 may be operatively similar to a matching engine embedded in web service 12 of FIG. 1 or in communication with the web service, as seen in FIG. 2.

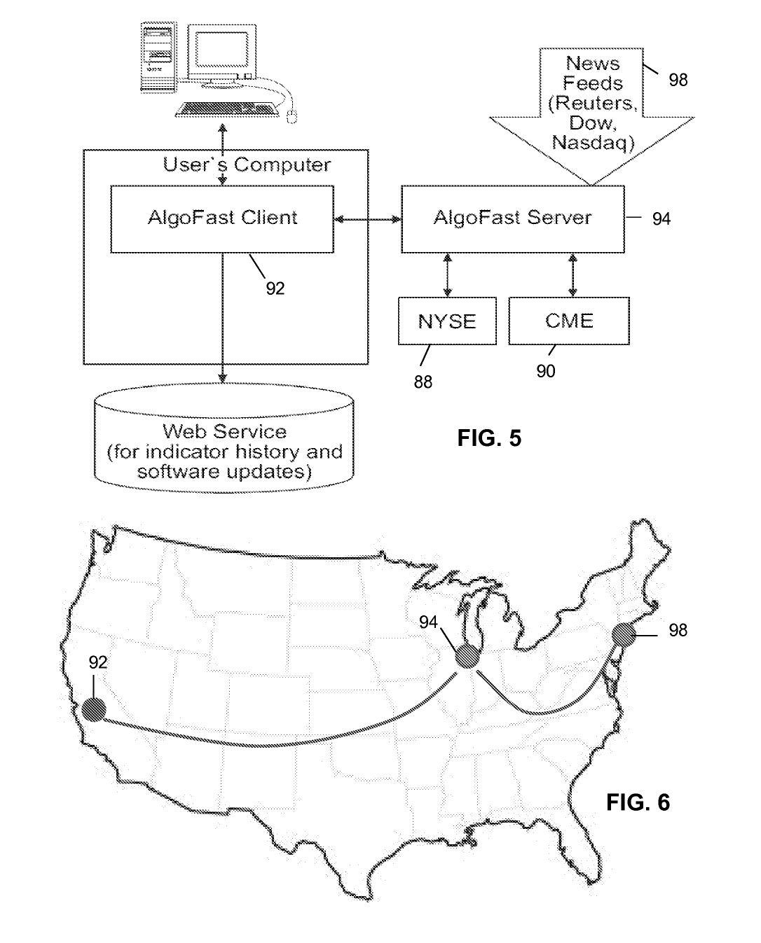

Turning now to FIGS. 3-4, one example of a system having a client side matching engine with a downloadable front end is shown.

As seen in FIG. 3, Interactive Brokers and CQG both offer a “client side API” in which a third party provider can write to the API, but only if the IB 78 or CQG 80 software is installed on the same computer as the third party software. In this version, the user may download both the system client 72 and matching engine software directly to one computer. The matching engine software and the client software can be coupled into one piece of software (although they alternatively may be separated, e.g., putting the matching engine piece next to the exchange, as in the server side version described below). Decoupling the client and matching engine and placing the matching engine on a server next to the exchange or broker may be desirable if the trading venue offers a more flexible API.

In the client side version, the news feeds must be distributed out to every instance of the software either in a direct feed or over the internet. In the example shown in FIG. 4, users in Oregon 73, California 75, and Colorado 74 may create a strategy on the client 72. The strategies may be created and stored in a matching engine on the same computers as the respective clients, and the logic to send an order will be computed on the same machine that the strategy is created. Next, news 82 may be sent from its origin, e.g., New York to a distribution system in Chicago 84. The distributor sends the feed out over the internet to the multiple clients in Oregon 73, Colorado 74, and California 75. Then the matching engines on each of the users' own computers will process the events independently (as opposed to in a single, centralized place) to determine whether the users' strategies have been triggered. Finally, triggered strategies then may send orders to the brokers or exchanges in San Francisco 86 and South Dakota 87 for fulfillment.

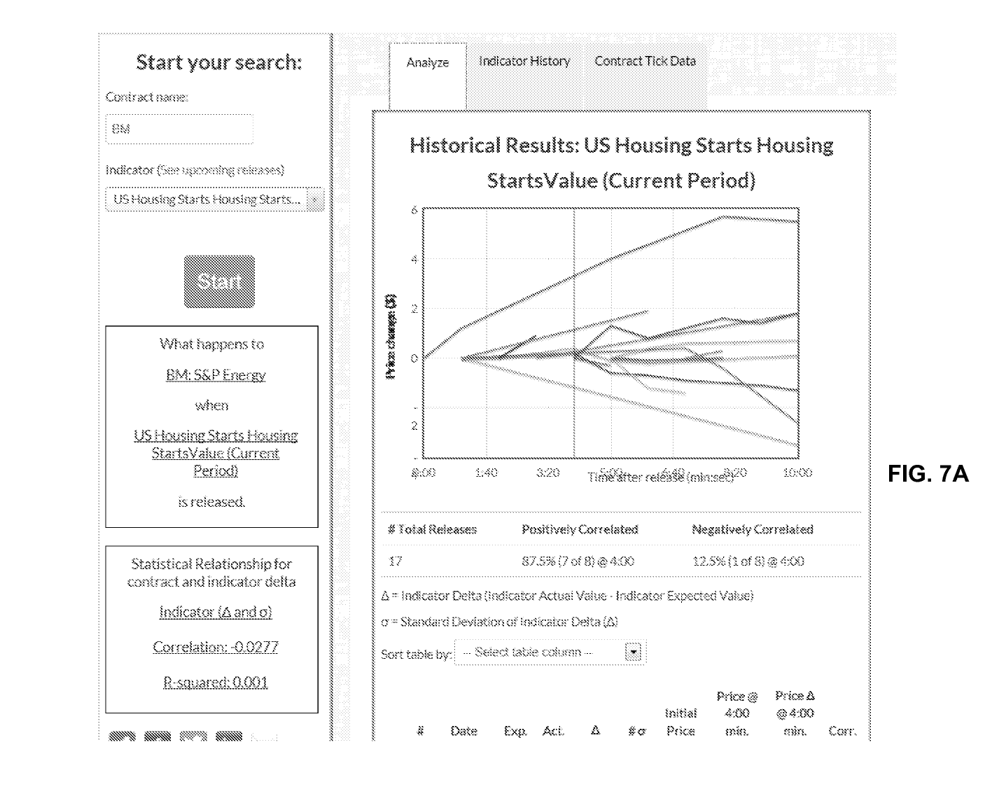

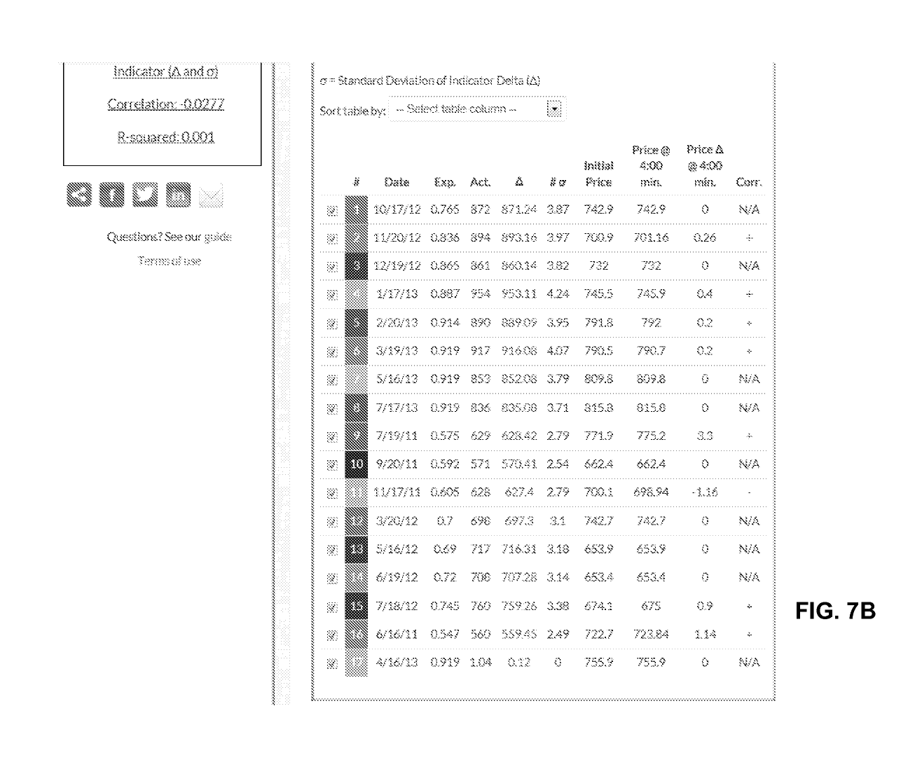

Each of these implementations is in contrast to a server side matching engine, one example of which may be seen in FIGS. 5 and 6.

In the server side matching engine version, users download only the client software directly to their computer. The server software resides on a separate computer or server 94, usually located as close to the exchange as possible because a shorter path for news routing may be created as well as a shorter, faster path for the order to be sent from the matching engine to the exchange. The news feed may be sent directly to the matching engine, bypassing the client for faster execution. For example: The client 92 may be in California and may create and activate a strategy. Once activated, that strategy is sent to the server in Chicago 94, since it is closer in proximity to the desired exchange, e.g., here, the Chicago Mercantile Exchange 90. News 98 then may be released out of New York and sent directly to the server in Chicago to determine whether the strategy has been triggered and whether its order should be fulfilled. If the strategy is triggered, the order would be sent directly from the server 94 to the exchange 90. Because the news path does not go all the way to California, it travels along a shorter, faster path to the matching engine, and the order takes a shorter, faster path from the matching engine to the broker or exchange.

The different versions, e.g., the cloud matching engine version and the downloadable version, can be combined. For example, a strategy stored on the cloud version can be taken out of the cloud Strategy Database and moved to a specific physical server, which may allow for a faster path for the machine readable news to travel on an optimized network and faster processing of the matching engine on optimized hardware.

Likewise, a strategy stored on the server side matching engine that is created either on the downloadable user interface or the web version and placed directly onto a physical server can be taken off of the physical server and placed into the cloud. This is done when a physical server needs to be rebooted, when a particular market is closed, or when a brokerage or exchange API has a forced logoff, as discussed in the Strategy Rollover System section, below. The strategy can then be placed back on the appropriate server when the server is back up, the market opens, or the API allows for reconnection. This allows for servers/computers to be turned off and/or replaced while still keeping the strategy running, even when the markets are closed.

Additional features of the system are discussed in greater detail, as follows:

Historical Data (Contract Price Data/Event Data) & Analysis Tool

Returning to FIG. 1, the system 10 may include a historical data tracker and analysis module, which may analyze previous market reactions to the change in an event. As a research tool, this module may permit the user to determine a decay of correlation between event delta and price change. In one aspect, this also may permit a user to analyze an optimal or desired time relative to release or change of an event at which to have an order executed.

As discussed above, event data may be stored in a cloud-based database, such as event database 20. System queries then may be sent to the web service, which has access to that database. Requested information would be looked up in the database and returned by the web service, e.g., in JSON format, in order to complete the user's request.

In order to implement this module, the system may receive an event/trigger and contract selection from the user. Upon receiving the user's selection, system 10 may determine if and when the selected event was released or updated. The system then may retrieve event data for a certain time span after that release. By default, this time span may be set to ten minutes, although other time spans are possible.

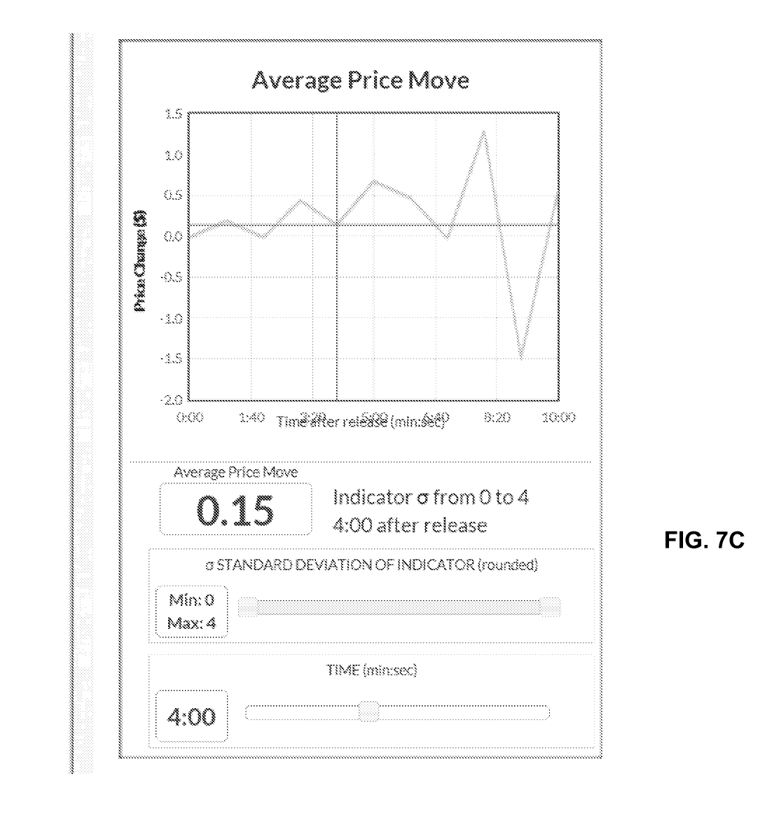

As shown in FIG. 7A, the system then may display to the user a graphical depiction of the price change vs. the time after release for a given delta (where delta=actual—expected). Delta may be depicted in absolute numerical values, in percentage, in standard deviation, etc.

It is possible that the system has data for more than one instance of a release of an event. For example, if the event is the U.S. unemployment rate, which rate is released monthly, system 10 may include twelve separate instances of data in a one year time span for this event. As such, the system may permit users to toggle on and off the instances of data that they do or do not want considered in the analysis. In the example shown in FIG. 7B, the event is US Housing Starts Housing StartsValue (Current Period), and the system has data relating to 17 total releases of this event.

The system then may perform a statistical analysis to determine the degree to which the event and contract may be related. Multiple statistical methods of performing this analysis may be accomplished, as would be appreciated by one of ordinary skill in the art. In one embodiment, the analysis may include determining a delta, i.e., a difference between actual and expected values, as well as a standard deviation for those values. The analysis also may include determining a statistical correlation and an r-squared coefficient of determination between the event and the contract and then presenting those values to the user.

The system may permit the user to drill deeper and/or fine tune those results, prompting the user to determine either or both of the degree by which an event value differed from an expected amount and a time after release or change of the event. In the latter case, the user may provide a time value, and an indicator such as a line may be added to the graphical display in FIG. 7A to depict that moment in time. The system then may calculate and display to the user a number and/or percentage of the data sets that reflect a positive correlation at that time and a number and/or percentage that reflect a negative correlation.

In the former case, the user may be able to set one or both of a minimum and maximum standard deviation of the event delta. Varying these numbers may alter the correlation and r-squared numbers and further may result in re-calculation and re-displaying of the graphical representation of price change vs. time after release, because it may vary the identity of the data sets that are used for both those calculations and that display. For example, modifying the standard deviation from zero to one may result in removing those data sets in which the standard deviation of the event delta were between zero and one (or between zero and 0.5, if the system implements a rounding technique).

In this way, the user quickly and easily may be able to determine visually what relationship, if any, may exist between an event and a contract over a time span. The user may be able to take a more aggressive stance by viewing and relying upon data sets with larger standard deviations, or the user may take a comparatively less aggressive (albeit potentially less definitive) stance by including those data sets with a smaller variation.

Turning now to FIG. 7C, the system also may calculate and display an average price move based on the historical data. Using the data sets that fall within the standard deviation range selected by the user, the system may calculate an average price move at each time unit and then display that average over the determined time span. The user also may indicate the average price move for the contract at the time after release selected by the user. Such an indication may include including cross-hairs on the graphical display of average price change vs. time and further may include numerically displaying that information separate from the graph.

This tool may be implemented by a user to generate one or more strategies for transmission to strategy database 18. For example, the user may be able to determine what correlation, if any, may appear to exist between an event and a proposed contract or if a correlation exists only above or below a certain delta or standard deviation. The user also may be able to determine how frequently an event varies positively or negatively with respect to an estimated value and further how frequently those variations are within a desired standard deviation range. From this, the system may receive a user's selection of event and contract directly from this module. The system may prompt the user to determine a type of transaction (buy/sell) and a price for the transaction.

Time Based Execution:

105B-1 Insider Stock Sale Plan: A user may want to schedule a trade for specific time or date of execution based on the restrictions of an IPO or other blackout trading period. By recording the date and time of the sale of stock, or defining a computer based algorithm, and employee can prove that a plan had been in place prior to the sale and the stock was not sold based on more recent insider information subsequent to the creation of the strategy.

Alternatively, a user may want to send an order to a broker or exchange as close to or at the precise moment the market opens. Because many exchanges use a “FIFO” First In First Out priority system, it is beneficial to place those orders as quickly as possible.

In addition, this module may facilitate the creation of a transaction that may be a variation on the simple strategy described above. Instead of generating a transaction that will be sent for fulfillment once the event is triggered, the transaction may include a time-delay component. For example, instead of immediate fulfillment, the transaction may be sent for fulfillment at the time after event release selected by the user for analysis in this module

Additionally or alternatively, this module may be an effective tool for assistance in generating an exit strategy for the user. For example, the user may generate a transaction that is executed as soon as the event is released. The user then may use the time-after-release modifier to determine a time after event release that represents the largest change from the value of the event at that time of release. From that, the system may generate a second, exiting transaction to occur, e.g., at the time of the largest change or when a desired price per contract is met, whichever occurs first.

Strategy Rollover System

Although users may wish to generate strategies at all times of the day, it may not be possible to implement those strategies at all times. For example, most exchanges have some time period where all trading is shut down and/or when servers may be shut off or otherwise rebooted on a daily basis, e.g., after the close of trading. Similarly, an online broker may kick users off its system around the same time and may force them to log back in.

It is during these shutdown times that users typically reboot their computers and servers, and strategies created but not executed prior to these cutoffs may be lost during the reboot. Additionally, strategies created after these cutoffs but not entitled to after-hours trading may not be executed if the user does not have sufficient permissions, and these strategies subsequently would be lost as well.

As discussed above, the different versions of the system may be combined, and this combination may alleviate one or more of the problems described above. In one aspect, the combination may involve migrating a strategy created on a downloadable version and placing it directly onto a physical server and/or placing it into the cloud. This is done when a physical server needs to be rebooted, when a particular market is closed, or when a brokerage or exchange API has a forced logoff. The strategy can then be placed back on the appropriate server when the server is back up, the market opens, or the API allows for reconnection.

Alternatively, it may be possible to just leave the strategies in a cloud-computing environment and not need to migrate them to a server if latency is not a significant issue. Speed may be enhanced by storing data in a local storage, and it may be enhanced further by caching the data in memory.

Additionally, strategies that are triggered after hours or during market closed hours can send orders to the broker (if applicable). Some brokers and exchanges will accept orders during after hours and execute them at the open. If a broker does not accept the orders, the system can send the orders either at the open or not at all depending on user preference.

Each strategy may be assigned an event ID, which may be a unique value created from input data. Thus, it may be possible to keep track of strategies before, during, and after the migration by ensuring that the event IDs remain the same.

Strategies may be saved in a flat, e.g., non-SQL, database in a machine-readable format. One such format may be JSON, although other strategies are possible.

The strategy rollover system allows clients to create strategies and let them run even after they've logged off system 10, turned their computer off, and could be doing anything else at the time their strategy is fired.

There are several ways that the system can connect to a broker. Usually any institution using the Financial Information Exchange protocol (FIX) will have a direct connection over TCP that does not go down. Some brokers and exchanges are now offering alternatives for connection as needed. One example is using Oauth connections with REST APIs where the connection is made only when needed.

Additionally, using Oauth or similar protocol helps protect user secure access information such as passwords. Because traffic is going over the internet, it is more susceptible to attacks. Through Oauth, or other similar protocols, an access token is given to the system for authentication instead of the username and password of the client. The token initiates the connection between the system and Traider (or another broker), when the user connects through system 10 to their brokerage account.

An access token is a security identification token used for authentication, and is sent in every message that goes to the broker. Without an access token, the connection to the broker will fail.

Each access token has an expiration time and date, usually 24 hours, as in the case of this example. The access token can be used may times before it expires. In order to regain access after expiration, the system might force the user to relink to the service (Traider, as used in this example) to get a new access token, or the system could use a refresh token.

In the system, when the request is made for an access token, it is given by the host, and a refresh token is also given. The refresh token is used to request a new Access token.

The system sends a refresh token in two scenarios, both occur when a strategy has been triggered. In the first scenario, the system checks the expiration period of the access token to determine if the access token is close to expiration, because it could expire while in transit to the broker. The system sends a refresh token is sent to the host, and new access token is given to replace the expired access token.

Some Oauth implementations will send the access token, and if it gets rejected, then they'll send the refresh token.

The second scenario is if the token has already expired. The system sends a refresh token is sent to the host, and new access token is given to replace the expired access token.

If a strategy is triggered and the access token has expired, or the access token is getting close to the time of expiration, system 10 will forgo the process of sending the order to the broker with the original access token, and instead send a refresh token to the broker in order to receive a new access token prior to sending the order. In each of these scenarios the system saves time.

Also, the system takes additional steps to secure the refresh token. The tokens are stored encrypted with AES-256-CBC on the system's web server's database. They are only sent to the broker directly and never to the client or any other location. When the tokens are sent to the broker the connection is encrypted with SSL. If the tokens were ever compromised the broker has the ability to disable them so they would be useless to an attacker.

Typically Oauth is used with REST based web applications, but the system can also use it with non-REST based connections and other networking protocols like the Financial Information Exchange Protocol (FIX). However, Oauth only works when the counter-party (broker or exchange) accepts the use of it.

Pre-Creating an Order

Most strategies generated by a user ultimately are created for the purpose of generating an order, i.e., either buying or selling a certain number of contracts at a certain price. Alternatively, a strategy may be set up to generate a warning either through text or email instead of sending an order. It is possible to create an order or order ticket each time a user places the order. However, when you enter a calculation into a calculator or a program that performs the same function, it takes up processing power and time to perform the function. As such, whenever there is a calculation for the quantity and/or price of an order, the calculation should be done before the event arrives. Then, if the price and quantity are fixed, the entire order should be filled out and ready to go.

Thus, the system may create a ticket for each pairing of a range of price and quantity values. Each pairing may be cached in memory and called whenever a user wishes to use that pairing in a trade. Accessing the cached tickets may be significantly faster than trying to create a ticket anew each time a user wishes to place an order.

Pre-created orders may exist in the host computers memory. In one aspect, the orders may be saved on a hard drive, although this option may be less preferable, as it may be faster to just recreate the order than to access it on a hard drive. Order pre-creation may be particularly helpful in the case where the system is instantiated with a server co-located proximate an exchange, as in the example shown in FIG. 3.

The system may create a temporary table in order to determine how many events relate to each strategy in the table. These events may be run in parallel, although some may need to be queued, depending on the number of requests received. In order to speed up the process, multiple instances may be run.

Order Pre-Creation is useful for Gradient Scale Orders, where the quantity and price are determined by the strength or weakness of an event like an earnings report or economic number like GDP (Gross Domestic Product). For the gradient scale, if you have three ranges for an event, i.e., good, strong, very strong, where three different prices and/or three different quantities would be assigned to each event range, three separate order tickets should be created. Then when the event comes, there are only three possible trigger ranges to choose from instead of the matching engine doing a calculation for price and quantity, which would take much longer for a computer to perform.

Order Pre-Creation is also useful when the price of an order is based on the historical price action. For example, a trader may want to place an order to buy at or below the 1 week moving average of the stock. The moving average can be calculated and stored in a specific interval like once per second or once every 10 seconds. In this situation, no calculation has to be made for price. The price is updated every interval to the same number as the moving average. The event comes, triggers the strategy, and the order is sent without doing a calculation for price. The purpose is to remove any calculation performed after the event trigger has arrived, so that an order is sent to the broker or exchange faster, thus giving a higher probability of receiving a favorable price or quantity or being filled at all.

Analyst Rating Index

In addition to extracting events or triggers from news sources, system 10 may include an analyst rating index to determine inputs into the trading system.

For example, a user may set up a strategy that says: “If the index goes below 0 (or whatever level they choose) then I will sell out of the stock.” As a second example, the user may set up a strategy that says: “If the index drops by more than X (1) within time Y(1 hour, or 1 day, etc.), then I will sell out of the stock.”

Data may be obtained in a machine-readable format, e.g., XML, which may then be converted into numbers that can be used by the system. Data extraction may be similar to that for obtaining events from news feeds, i.e., data streams may be fed into parser 22, where data identifying both the rating agency and its ratings for one or more contracts may be extracted and passed to a database in communication with web service 12.

One or more ratings agencies may be used as data sources. Ratings agencies may provide ratings for each contract, and those ratings may be updated either periodically or, more likely, at random intervals.

Different agencies use different scoring systems to provide their ratings. For example, a first category of agencies may use a three-tier scale. Examples of these tiers may be:

| | | |
|---|---|---|
| 2 Buy | Outperform | Positive |
| 0 Hold | Neutral | Neutral |
| −2 Sell | Underperform | Negative |

Other agencies may use a five-tier scale, such as:

| | | |
|---|---|---|
| 3 Strong Buy | Buy | Strong Buy |
| 1 Buy | Accumulate | Buy |
| 0 Hold | Hold | Neutral |
| −1 Sell | Reduce | Sell |
| −3 Strong Sell | Sell | Sell Short |

Still other agencies may use a four-tier scale. Various examples of these scales include:

| | |
|---|---|
| 3 Strong Buy | Strong Buy |
| 1 Buy | Accumulate |
| 0 Neutral | Neutral |
| −2 Sell | Sell |

2 Buy
1 Outperform
−1 Underperform
−2 Sell

2 Buy
0 Hold
−1 Underweight
−3 Sell

2 Buy
0 Hold
0 Neutral
−2 Sell

2 Buy
0 Neutral
0 Hold
−2 Sell

In order to use ratings as event inputs, in one embodiment, the system may rely on each agency's scale and present the user with the tiers in the selected agency's scale for selection as a user input. In other words, if the user selects an agency that has a five-tiered system, the system may generate a template for a proposed transaction along the lines of “If agency's rating for contract X is [one of the five tiered options], then take some action.” Similarly, is the user selects an agency that uses a three-tiered system, the system may generate a template for a proposed transaction along the lines of “If agency's rating for contract X is [one of the three tiered options], then take some action.”

In another embodiment, the system may normalize the different ratings scales in order to provide the user with a single template, regardless of the agency selected. This embodiment may be most suitable when the user is concerned with a direction of rating change, as opposed to the value of the change itself. For example, the system may generate a proposed transaction in which the trigger is the upgrade, downgrade, or lack of change in the agency's rating of a contract.

In still another embodiment, the system may rely upon the ratings of multiple agencies in establishing a trading trigger. The system may use inputs from all agencies that rate the desired contract or, alternatively, the user may be able to toggle on and off the agencies whose ratings contribute to the trigger. In either case, the system may generate an index average by assigning point values such as those shown in the tables above to the different ratings levels. For example, the system may add the various agencies' ratings scores for the contract together and then divide by the total number of ratings agencies used. In this case, the system may be able to present the user with an option to execute a trade based either on a net increase/decrease/no change (“If agency index average [increases/decreases/stays the same], then take some action”), based on an actual index value (“If agency index average is ([number] or [at least number]), then take some action”), or based on a relative index value (“If agency index average [increases/decreases] by at least some [number] amount, then take some action”).

In order to make a calculation of the agency index average more efficient or easier, each agency may be assigned a ratings type identifier based on the type of scale that the agency employs and also may be assigned a unique identifier. Each identifier may include a map of ratings to ratings values. Then, when the system seeks to determine an index average, a processor on a computer may access the agency data submitted by parser 22, determine which agencies include a rating for the item to be traded, prompt the user to select which agencies to include in the analysis, and receive the user's selections. Using those selections, the system then may retrieve an agency identifier and rating from that data, cross-check the identifier with an internal record of identifiers, obtain a ratings type identifier from the internal record, and analyze the agency rating to determine a numerical value to assign to the rating, given the ratings type identifier. The system may repeat this process for each agency selected by the user and then average the numbers. The system may perform this option at a first time, which may be when the user wants to know a current index average and then again at one or more later times in order to determine if/when this event has been triggered.

Information received from parser 22, mappings between agency identifiers and ratings type identifiers, and calculated index averages may be stored in memory, in a cache, in a relational database, etc., for easy access and retrieval by the system.

Technical Charting Based Event Trigger Module

Unlike many of the triggers described above, e.g., a GDP amount or percentage change or a change in the unemployment rate, certain triggers may not be one-time events or point-in-time releases. Instead, these triggers may be constantly changing indicators, or they may require more than simply a comparison of the newly-released trigger value with the immediately previous trigger value.

For example, one such trigger may be if the price of a contract hits a 52 week high. In this case, the actual value of the contract and the previously-released value of the contract may not provide sufficient information in order to analyze whether the trigger has been activated. Instead, the system may need to chart multiple instances of the triggering indicator and perform one or more different calculations in order to arrive at the trigger value. In this example, the system may store closing values of the contract for each day within the past 52 weeks and then compare the most recent value against those historical values. The storage may be a dynamic process, whereby receipt of a new trigger number may be accompanied by deletion of the oldest stored value.

Receiving and processing data may be accomplished in one or more ways. In a first example, some feeds send data to the system in a streaming format, i.e., this data may be constantly “pushed” data. Alternatively, data providers may provide “pull” or “REST” based APIs where the system has to request the data. In the former case, the streaming feed will have to be broken down into snapshots periodically to be sent to the event database, whereas, in the latter case, the REST data is already in broken down into snapshots.

In either case, the system may include a calculation engine to determine the trigger value from the received data. Once the calculation has been done, the system may transmit the results to the event database for the system to use in the event that a user establishes a transaction with this charting based event as a trigger.

In still another aspect, an external data provider may perform the necessary calculations and then, using either a “push” or “pull” configuration, transmit the calculated values to the system, so that they may be immediately ready for use as trigger values.

Dynamic Pricing Module

In addition to serving as a trigger value, this historical or “technical charting” data can be used to set the price on an order ticket for a user's proposed transaction. For example, the user may generate a proposed transaction that says “if earnings for company A come out above $X/share, I will buy Y shares at the 52-week moving average.” In this case, the trigger, i.e., the earnings amount, may be treated like the other non-charted triggers described above, while the 52-week moving average changes constantly. The system will not be able to verify what that moving average value is until the transaction is triggered. As such, the system may dynamically pull this pricing data when the event triggers the strategy.

Dynamic Quantity Module

Similarly, the user can dynamically set the quantity of an order ticket, i.e., the user can schedule a transaction where the quantity amount is unknown at the time the user generates the transaction. For example, the quantity can be set to the amount of shares or contracts that are currently in the user's portfolio, which may be different quantity when the transaction is triggered than when it was generated. Example: If company A's earnings are below $X/share, I will sell the amount of shares of company A in my portfolio at $700.

User Defined Events

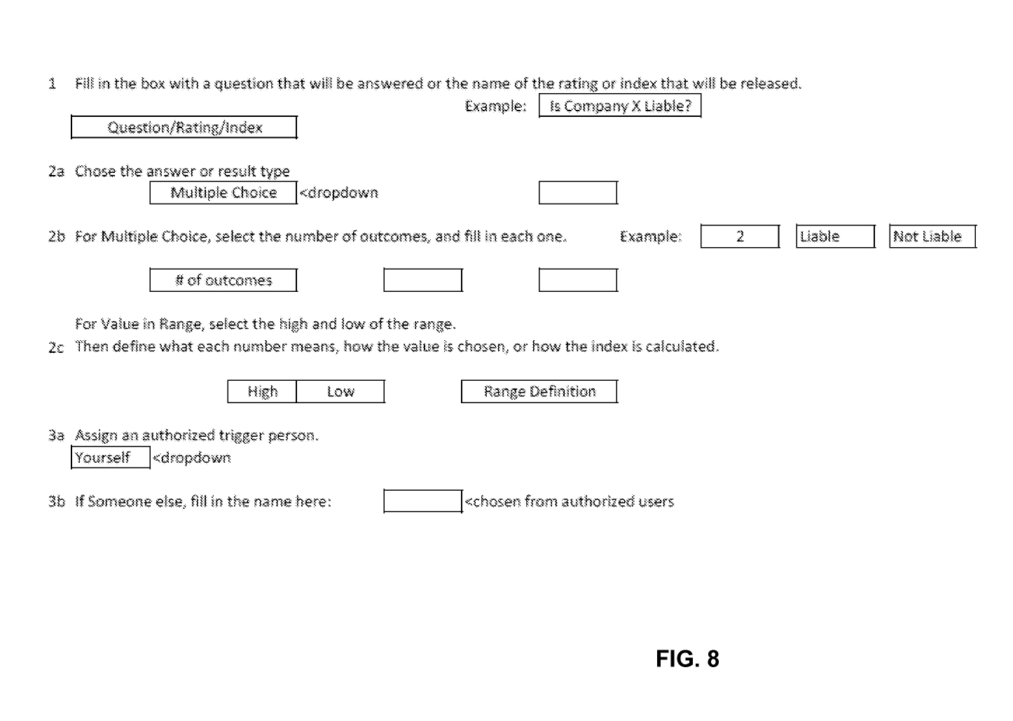

In still another aspect, system 10 may provide users with the ability to create their own event for either their own private consumption or for distribution. Once created, a user may give access to other users either to use the event as a trigger or to provide access necessary for others to verify or confirm that the event has occurred. Alternatively, the user may be able to trigger the event himself. One example of a series of menu options for establishing a user defined event may be shown in FIG. 8.

A graphical user interface (GUI) may be used to create strategies. The user builds a strategy by literally spelling it out in plain English, selecting indicators, conditions and results to determine the cause and effect of the strategy. The GUI may also include a list of the user's orders and order status. The GUI may also include a dashboard for the user's account.

For example, a user may believe that a current court case may affect the value of one of the parties' stock, such that a judgment of liability may cause the stock price to fall shortly thereafter. In that case, the user may create a strategy that says “If Company X is found liable in Case Y, I will sell 100 shares of Company X's stock.” The user may be able to know the outcome of the trigger before it has a chance to become widely publicly available and, as such, may enjoy a temporal advantage over other users that may be looking to acquire or divest themselves of Company X's stock. For example, the user may be sitting in the courtroom waiting to hear the judgment. Alternatively, another user may have been granted access by the user that created the strategy, and that other user may be in the courtroom. When the verdict comes in, the user in the courtroom may be able to access system 10, e.g., via a mobile interface, and may set the trigger status.

At that point, the event would be recorded in the event database. Rather than analyzing all strategies in the database, the system may restrict its analysis only to user IDs that were granted access to the event.

System 10 may permit a user to make his or her event available to other users, either for free or for a fee, which may be paid to the user, to the system, or to both. In order to improve accuracy of information, a user's credibility in updating a trigger may be important. As such, the system may include trigger verification features, which may be defined by the event creator. For example, the system may set a requirement for confirmation of the trigger by one or more other users.

The system may include expertise, credentials, or academic degrees in user profiles, such as PhDs or Master's, police or media credentials, etc. The system may include a minimum credibility score. The system may also provide for photographic evidence.

Additionally or alternatively, system 10 may retrieve GPS information from the user's mobile device. This information may be used to determine the user's location in order to verify that it comes from the same location as the event serving as the trigger, give or take some system-defined margin of error. In the event that multiple user corroboration of a trigger is required, the system may analyze the GPS location of each user to verify that they all are at the same location, again, within some system-defined margin of error. Moreover, the system may fine, suspend, or terminate the account of a user who it determined had provided inaccurate trigger information.

System Optimization Techniques

In order for the system to work more efficiently, it may be useful to prioritize events scheduled for a given time period. One method of prioritizing may be to analyze a user's orders by focusing on those orders that have fewer constraints left to be filled for execution. For example, if a user sets up two transactions, where a first transaction relies on favorable movement relating to two events, one of which already has changed but one of which has not changed yet, and a second transaction relies on favorable movement relating to four events, one of which has changed and three of which have not, the system may devote more resources to determining if and when the first trade conditions are met and the trade is to be executed. Conversely, if the first transaction relies on two events, neither of which has been updated, and the second transaction relies on four events, three of which have been updated, the system may devote more resources to the second transaction since it relies on only one more trigger in order to be executed, even thought the first transaction relies on fewer constraints overall.

In another embodiment, each event or trigger may be given a unique event identification code, which in the case of WINDOWS Azure table storage may be referred to as a partition key. When a transaction is generated, the partition keys associated with the events used in the transaction may be recorded. Then, when an event is released or updated, the system may check to see what transactions include that partition key and then only analyze that subset of potential transactions to determine whether the other conditions in each transaction have been met, thereby necessitating fulfillment of the transaction.

Another system optimization technique may involve scaling the system by creating multiple roles handling different tasks and then running multiple versions of these roles on multiple instances. Web service 12 may manage only two roles, i.e., a web role and an event trader worker role, which may be considered virtual machines running in data centers such as WINDOWS data centers, AMAZON S3 data centers, or data centers of other cloud service providers. The web role may process and store all the strategies submitted by users and all the event information originating from event parser 22. Conversely, the event trader worker role may process event messages from the web role and route an order to web server (every event message gets sent out from web role to worker role, permitting the web role to be available for the next task to be processed).

In order to optimize system 10, these tasks may be executed in parallel, e.g., by making use of a thread pool supported by a C# .NET platform or by implementing parallel processing in another language. Another technique may be to create and run multiple versions of a service (or roles) that run on two (or more) instances, where each instance can be considered as an independent hardware running in a hosted environment.

In each of the system configurations discussed above, i.e., server side matching engine, client side matching engine, and web based, the server can be set up with a Linux operating system with a kernel bypass network interface card (NIC) such as Solarflare. The server preferably uses a multicore processor with multithreaded software to distribute processes simultaneously. Increasing RAM and overclocking may be used to increase speed of the hardware. Relatedly, the system may incorporate special cooling systems, which may permit even more aggressive overclocking, leading to further speed increases.

Certain components of the system may be placed on a field programmable gateway array (FPGA) chip or an application-specific integrated circuit (ASIC). These components may include one or more of: Matching Engine 26, News Parsing Engine 22, Client Messaging Zero MQ (may share the price feed instead of each instance of the Server on one machine having its own price feed), Encryption Engine (part of a Client Messaging System), Risk System (Pre-trade risk checks risk limits when the strategy is activated, prior to the trade being executed, eliminating a risk check step during order execution), and/or Postgres/Local Database (preferably taking client or historical information off of the server and storing it in the user interface to speed up the hardware).

Data may be transmitted on one or more legs along its path along a microwave or millimeter wave network with fiber optic backup. By using a microwave or millimeter wave network, a more direct path from origin of the news to the exchange can be created without having to place fiber optic cable between the two.

Similarly, as discussed above, the system may take advantage of colocation, i.e., implementing a network with the shortest path from the origin of the news to the exchange in order to increase speed of execution. The server can be collocated either next to the exchange, next to the news source, or anywhere in between as long as the path from news origin to exchange is as short as possible.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

1. A system for creating event-driven financial transactions, comprising:
a web service in communication with a plurality of users;
the web service operatively coupled to a strategy database storing a plurality of pending transactions and an event database storing identification information about a plurality of transaction triggering events; and
the web service in communication with a data parser, the data parser configured to receive data from one or more sources, convert the data into a format usable by the system, and transmit the converted data to the event database.

2. The system according to claim 1, wherein the event database comprises a first table and a second table;
each table including a first column containing user identifications, the user identifications being unique to each user, and a second column containing strategy record identifications, each strategy record identification corresponding to an entry in the strategy database;
the first table including a third column containing a complete strategy record; and
the second table including a third column containing event identifications, the event identifications being unique to each of the transaction triggering events.

3. The system according to claim 2, wherein a transaction includes a plurality of transaction triggering events; and further wherein the second table includes a separate row for each of the transaction triggering events for the transaction.

4. The system according to claim 1, wherein at least one of the transaction triggering events is user-created.

5. The system according to claim 1, wherein at least one of the transaction triggering events relates to a change in a rating agency rating of a contract.

6. The system according to claim 1, wherein the system includes a calculation engine configured to analyze a transaction triggering event value in comparison to a plurality of previous transaction triggering event values.

7. The system according to claim 1, wherein a pending transaction stored in the strategy database includes a price component that is configured to be calculated when the transaction is triggered.

8. The system according to claim 1, wherein a pending transaction stored in the strategy database includes a quantity component that is configured to be calculated when the transaction is triggered.

9. The system according to claim 1, wherein a plurality of rating agencies have a rating for a contract, and wherein at least one of the transaction triggering events relates to a change in an average among the ratings.

10. The system according to claim 1, wherein at least one of the pending transactions includes instructions to wait a user-defined period of time after the occurrence of one of the transaction triggering events before carrying out an order.

11. The system according to claim 1, wherein the event parser is configured to parse the data into JSON format.

12. The system according to claim 1, wherein the event parser receives data according to at least one of a TCP/IP protocol and a UDP transmission model.

13. The system according to claim 1, wherein the strategy database is configured to receive a plurality of distinct strategies from a distinct server in communication with a brokerage or exchange API, store those strategies until the distinct server is rebooted, until a market to which the strategies are to be sent reopens, or until the brokerage or exchange API allows for reconnection with the distinct server and then migrate those strategies back to the distinct server.

14. A method for generating and executing a financial transaction on a cloud-based computer system that includes:
a web service in communication with a plurality of users;
the web service operatively coupled to a strategy database storing a plurality of pending transactions and an event database storing identification information about a plurality of transaction triggering events; and
the web service in communication with a data parser, the data parser configured to receive data from one or more sources, convert the data into a format usable by the system, and transmit the converted data to the event database;
the method comprising:
receiving a plurality of proposed transactions from a plurality of user computers;
storing, for each proposed transaction, a first set of information relating to the transaction in the strategy database;
storing, for each proposed transaction, a second set of information relating to the transaction in the event database;
receiving a notification from the data parser regarding a change relating to a transaction triggering event;
searching the event database for all matching transactions that depend upon the change;
retrieving, from the strategy database, the matching transactions;
determining whether all triggering events for the matching transactions are met; and
transmitting, by the web service, orders corresponding to the matching transactions with all triggering events being met to a broker or to an exchange to be filled.

15. The method according to claim 14, wherein the event database comprises a first table and a second table, the method further comprising:
storing, in the first and second tables, a first column of data containing user identifications, the user identifications being unique to each user, and a second column of data containing strategy record identifications, each strategy record identification corresponding to an entry in the strategy database;
storing, in the first table, a third column of data containing a complete strategy record; and
storing, in the second table, a third column of data containing event identifications, the event identifications being unique to each of the transaction triggering events.

16. The method according to claim 15, wherein a transaction includes a plurality of transaction triggering events; the method further comprising:
storing, in the second table, a separate row for each of the transaction triggering events for the transaction.

17. The method according to claim 14, further comprising:
receiving and storing a user-created transaction triggering event.

18. The method according to claim 14, wherein the determining step comprises analyzing a transaction triggering event value in comparison to a plurality of previous transaction triggering event values.

19. The method according to claim 14, further comprising calculating a price component of a pending transaction stored in the strategy database when the transaction is triggered.

20. The method according to claim 14, further comprising calculating a quantity component of a pending transaction stored in the strategy database when the transaction is triggered.

21. The method according to claim 14, wherein at least one of the transaction triggering events relates to a change in a rating agency rating of a contract.

22. The method according to claim 14, wherein a plurality of rating agencies have a rating for a contract, the method further comprising:
determining a change in an average among the ratings; and
utilizing the change in average as a transaction triggering event.

23. The method according to claim 14, wherein at least one of the pending transactions includes instructions to wait a user-defined period of time after the occurrence of one of the transaction triggering events before carrying out an order.

24. The method according to claim 14, further comprising:
storing historical information relating to changes in the price of a contract;
storing historical information identifying the times and amounts of changes to a transaction triggering event;
mapping a relationship between the changes to the transaction triggering event and the changes in price of the contract.

25. The method according to claim 24, further comprising:
storing historical information relating a plurality of different releases of a numerically quantifiable transaction triggering event, the historical information including actual and projected values of event at and after occurrences of the event;
calculating an average change over time between the actual and projected values;
calculating a standard deviation for the average change over time;
receiving a user selection of a time after occurrence of the transaction triggering event; and
displaying to the user, for the time selection, an average change in the price of the contract.

26. The method according to claim 14, wherein the strategy database communicates with a web service, which is in communication with a distinct server, which is in communication with a brokerage or exchange API, the method further comprising:
receiving, by the strategy database, a plurality of distinct strategies from the distinct server;
storing those strategies in the strategy database until the distinct server is rebooted, until a market to which the strategies are to be sent reopens, or until the brokerage or exchange API allows for reconnection with the distinct server; and then
migrating those strategies back to the distinct server.

27. A method for generating and executing a financial transaction on a computer system that includes:
a web service in communication with a plurality of users;
the web service operatively coupled to a strategy database storing a plurality of pending transactions and an event database storing identification information about a plurality of transaction triggering events; and
the web service in communication with a data parser, the data parser configured to receive data from one or more sources, convert the data into a format usable by the system, and transmit the converted data to the event database;
the method comprising:
receiving a plurality of proposed transactions from a plurality of user computers;
storing, for each proposed transaction, a first set of information relating to the transaction in the strategy database;
storing, for each proposed transaction, a second set of information relating to the transaction in the event database;
receiving a notification from the data parser regarding a change relating to a transaction triggering event;
searching the event database for all matching transactions that depend upon the change;
retrieving, from the strategy database, the matching transactions;
determining whether all triggering events for the matching transactions are met;
prepare transmission for orders corresponding to the matching transactions with all triggering events being met; and
determining broker or exchange and identify transmission protocol.

28. The method according to claim 27 further comprising:
acquiring security identification token and refresh token for broker transactions;
encrypting the refresh token for further protection against unauthorized use;
providing the security identification token for sending broker transactions; and
transmitting, by the web service, to a broker or to an exchange the orders to be filled.

28. (canceled)

29. The method according to claim 27 further comprising:
determining if the security identification token is expired;
sending the refresh token to the broker;
receiving the new security identification token for sending broker transactions;
encrypting the refresh token for further protection against unauthorized use;
providing the security identification token for sending broker transactions; and
transmitting, by the web service, to a broker or to an exchange orders to be filled.

30. The method of claim 17 wherein the user-created transaction triggering event is from a user that has made the user-created transaction triggering event available to others.

31. The method according to claim 27 further comprising:
determining if the security identification token is near expiration;
sending the refresh token to the broker, prior to the expiration of a user's credentials;
receiving the new security identification token for sending broker transactions;
encrypting the refresh token for further protection against unauthorized use;
providing the security identification token for sending broker transactions; and
transmitting, by the web service, to a broker or to an exchange the orders to be filled.
